(19) United States
(12) Patent Application Publication
(10) Pub. No.: US 2005/0219470 A1
(43) Pub. Date: Oct. 6, 2005

(54) Digital light projector (DLP) and a method of fabricating the same

(75) Inventors: Chia-Chang Hsieh, Tainan City (TW); Hsien-Chun Tsou, TaoYuan Hsien (TW)

Correspondence Address: Ladas & Parry, 26 West 61st Street, New York, NY, 10023, US

(73) Assignee: BENQ CORPORATION

(21) Appl. No.: 11/098,141

(22) Filed: Apr. 4, 2005

(30) Foreign Application Priority Data
Apr. 6, 2004 (TW) 93109505

(51) Int. Cl. G03B 21/00

(52) U.S. Cl. 353/31

(57) ABSTRACT

A digital light projector (DLP) enabling to support at least two digital micromirror devices (DMD) with different resolution is provided. Appending with a predetermined resolution, the DLP comprises a scalar transform unit and an image control unit. The scalar transform unit has a plurality of scalar firmware respect to various resolutions including the predetermined resolution stored therein. The image control unit electrically connects to the scalar transform unit and has a DMD firmware and a register number respect to the predetermined resolution. While the DLP is operating, the scalar transform unit reads the register number and chooses a proper scalar firmware accordingly.

### BACKGROUND OF THE INVENTION

(1) Field of the Invention

The invention relates to a digital light projector (DLP), and more particularly to a DLP with alterable resolution by replacing elements contained therein.

(2) Description of the Prior Art

The devices for displaying pictures, in addition to the conventional CRT TV, now include PDP, LCD TV, projection TV and the like. The PDP and LCD TV are still very expensive. Moreover, LCD TV has view angle problem, and the display dimension is constrained by the limitation of glass substrate fabrication. The projection TV is quite bulky. On the other hand, projector overcomes most of the problems mentioned above. It is compact, easy to carry, reasonably priced, and has few geographic restrictions. With a flat wall, it can display pictures at a size not achievable by other facilities.

The present image projection techniques are divided into two main types: transmissive LCD panel and digital light processing. The transmissive LCD projector uses a LCD panel as the picture display device. Light of the projector passes through the LCD panel to generate images. The digital light processing projector (DLP) employs a Digital Micromirror Device (DMD) developed by Texas Instrument (TI) Co. to display images.

In the DMD technique, a light source is split into four colors (red, green, blue and white) by a high speed rotating color wheel (7200 RPM). The split light projects on a micromirror device. The micromirror device has numerous micromirrors. Digital signals that represent 0 and 1 drive those micromirrors to rotate to selected angles to reflect unnecessary light, and direct the required light to an incident lens. Through the principle of persistence of visual, lights of different colors are synthesized to become a colored image and present to human eyes.

Compared with the conventional transmissive LCD projector, DLP has a simpler structure, and can better meet the prevailing trend of thin and light requirements. Moreover, DLP adopts holographic image process. It not only conforms to the digitized home appliances direction, the image signals input into the DLP do not require digital/analog signal conversion, thus can provide a stable and undistorted image display. In addition, displaying the pictures through the micromirrors overcomes the limitation of image display caused by the transmissive rate of the LCD panel of the transmissive LCD projector. It also does not have the grid pixel pattern occurred to the transmissive LCD projector. Moreover, the micromirror has life span up to 100,000 hours. The chip can last eleven years even if it is being used 24 hours a day continuously. The aging problem also is less severe.

Refer to FIG. 1 for a typical DLP 100. It includes a frequency generation unit 110, a scalar transform unit 120, an image control unit 140 and a DMD 160. The scalar transform unit 120 has a scalar firmware F resided therein. The image control unit 140 has a DMD firmware D resided therein. The frequency generation unit 110 generates a frequency signal f. The specifications of the frequency signal f, scalar firmware F and DMD firmware D have to match the resolution of the DMD 160.

The scalar transform unit 120 is connected to the frequency generation unit 110, and executes the scalar firmware F according to the frequency signal f to transform input image data A to a digital image signal B corresponding to the resolution of the DMD 160. The image control unit 140 is connected to the scalar transform unit 120 and executes the DMD firmware D to transform the digital image signal B to a level signal C to control operation of the micromirrors in the DMD 160.

The present resolutions of DLPs mainly adopt SVGA and XGA specifications. Hence fabrication of the DLP has to support these two resolutions. To reduce fabrication cost, the elements used in the DLP should support these two resolutions as much as possible. However, in the typical DLP 100 as shown in FIG. 1, the DMD160, frequency generation unit 110, scalar firmware F and DMD firmware D have to be replaced when the resolution changes. Namely, to alter the resolution of the DLP, at least four elements have to be switched. This is a great burden to the production line and results in a higher cost.

Therefore, how to reduce the number of switching elements when the resolution of the DLP is changed without affecting the normal DLP operation is an important issue in production, and seriously affects the performance of production line.

### SUMMARY OF THE INVENTION

Accordingly, it is an object of the present invention to provide a DLP structure to reduce the required switching elements when the resolution is altered to lower the production cost.

In one aspect, the DLP according to the present invention can support two or more DMDs of different resolutions, including a predetermined resolution. The DLP includes a scalar transform unit and an image control unit. The scalar transform unit has a plurality of scalar firmware resided therein corresponding to a plurality of resolutions that include the predetermined resolution and output a digital image signal. The image control unit is connected to the scalar transform unit and has a DMD firmware and a register number resided therein to transform the digital image signal to a level signal to control the DMD. When the DLP is in operation, the scalar transform unit selects and executes a corresponding scalar firmware according to the register number.

### BRIEF DESCRIPTION OF THE DRAWINGS

The present invention will now be specified with reference to its preferred embodiment illustrated in the drawings, in which

FIG. 1 is a schematic view of a typical DLP structure;

FIG. 2 is a schematic view of an embodiment of the DLP of the present invention;

FIG. 3 is a schematic view of another embodiment of the DLP of the present invention;

FIG. 4 is a schematic view of yet another embodiment of the DLP of the present invention;

FIGS. 5A, 5B and 5C are schematic views of an embodiment of the DLP fabrication process of the invention;

FIG. 5D is a schematic view of the DLP of the invention in an operating condition; and

FIGS. 6A, 6B and 6C are schematic views of an embodiment of the DLP fabrication process of the invention when the resolution is altered.

### DESCRIPTION OF THE PREFERRED EMBODIMENTS

Refer to FIG. 2 for a first embodiment of a DLP 200 of the present invention. It aims to support two or more DMDs 260 of different resolutions. In the condition of matching a predetermined resolution, the DLP 200 includes a frequency generation unit 210, a scalar transform unit 220, an image control unit 240 and the DMD 260 equipped with the predetermined resolution.

The frequency generation unit 210 aims to generate a frequency signal f corresponding to the predetermined resolution. The scalar transform unit 220 has stored a plurality of scalar firmware F1 and F2 corresponding respectively to a plurality of different resolutions including the predetermined resolution. The image control unit 240 is connected to the scalar transform unit 220 and stores a DMD firmware D 1 and a register number S1 corresponding to the predetermined resolution.

While the DLP is operating, the scalar transform unit 220 reads the register number S1 through a communication circuit 270 connecting to the image control unit 240, and selects and executes a corresponding scalar firmware F1 based on the register number S1. Meanwhile, the scalar transform unit 220 also is connected to the frequency generation unit 210 to receive the frequency signal f1 to transform input image data A to a digital image signal B corresponding to the predetermine resolution. The image control unit 240 is connected to the scalar transform unit 220 and executes the DMD firmware D1 to transform the digital image signal B to a level signal C to control the DMD 260.

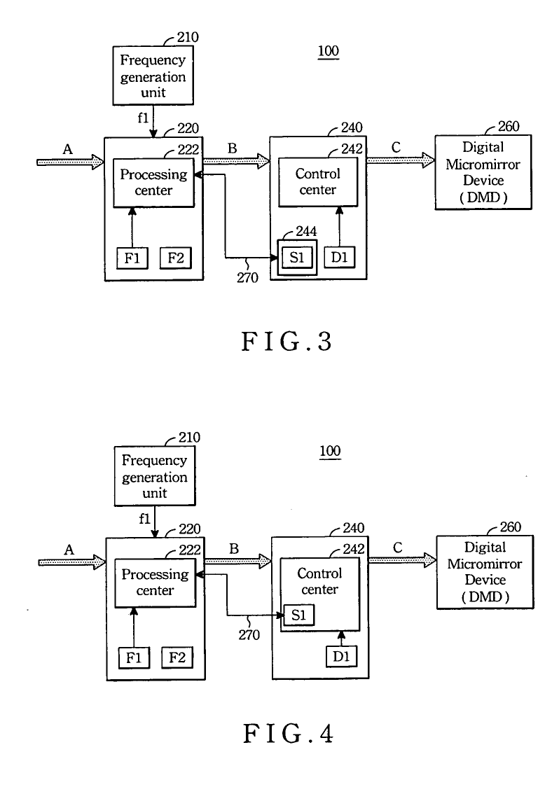

Due to the scalar transform unit 220 has to execute the scalar firmware F1, and the image control unit 240 has to execute the DMD firmware D1, hence, as shown in FIG. 3, the scalar transform unit 220 has a processing center 222 to execute the scalar firmware F1, and the image control unit 240 has a control center 242 to execute the DMD firmware D1 and a buffer 244 to store the register number S1. In addition, referring to FIG. 4, if the control center 242 has sufficient space to store the register number S1, the register number S1 may also be directly written into the control center 242 without the need to add the buffer 244. The processing center 222 requests the control center 242 for the register number S1.

Basically, the register number S1 merely serves as the selection basis for switching the scalar firmware F1 and F2. In the condition of switching the scalar firmware for two different resolution specifications, the register number S1 may be one byte, namely using 1 and 0 to indicate two different resolution specifications. For instance, if the scalar firmware adopts XGA and SVGA specifications, register number S1 may be set 0 for the predetermined resolution of XGA specification, and S1 may be set 1 for the predetermined resolution of SVGA specification.

Next, the communication circuit 270 may be an Inter-Integrated Circuit (I2C) to serve as the communication path between the scalar transform unit 220 and the image control unit 240. If the scalar transform unit 220 and the image control unit 240 have I/O ports, a conductive wire may be directly connected to the desired I/O ports to function as the communication circuit 270.

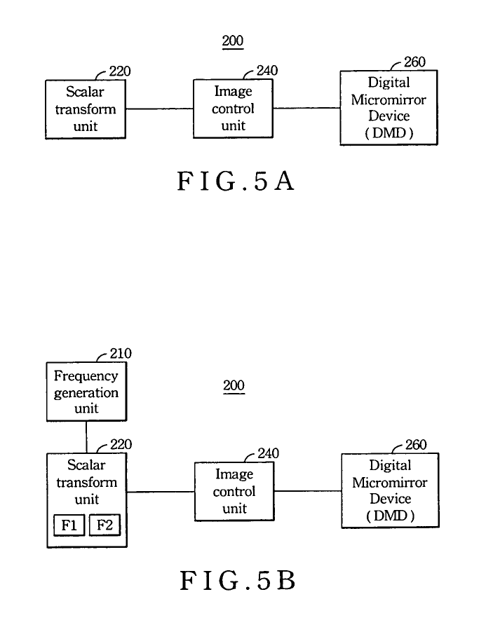

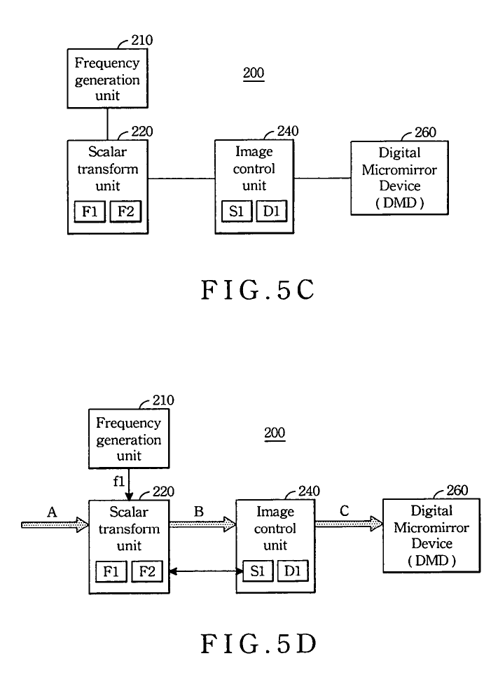

Refer to FIGS. 5A, 5B and 5C for an embodiment of the fabricating method of the DLP 200 of the invention. First, as shown in FIG. 5A, install a scalar transform unit 220, an image control unit 240 and a DMD 260 with a predetermined resolution in the DLP 200. Next, referring to FIG. 5B, install a selected frequency generation unit 210 to generate a frequency signal corresponding to the predetermined resolution; meanwhile, write a plurality of scalar firmware F1 and F2 into the scalar transform unit 220 corresponding to a plurality of resolutions including the predetermined resolution. Then, referring to FIG. 5C, write a DMD firmware D1 and a register number S1 into the image control unit 240 corresponding to the predetermined resolution.

Refer to FIG. 5D, while the DLP 200 is operating, the scalar transform unit 220 is connected to the image control unit 240 to request the register number S1 to confirm the resolution, and, based on the register number S1, executes a desired scalar firmware F1 to generate a digital image signal B corresponding to the predetermined resolution.

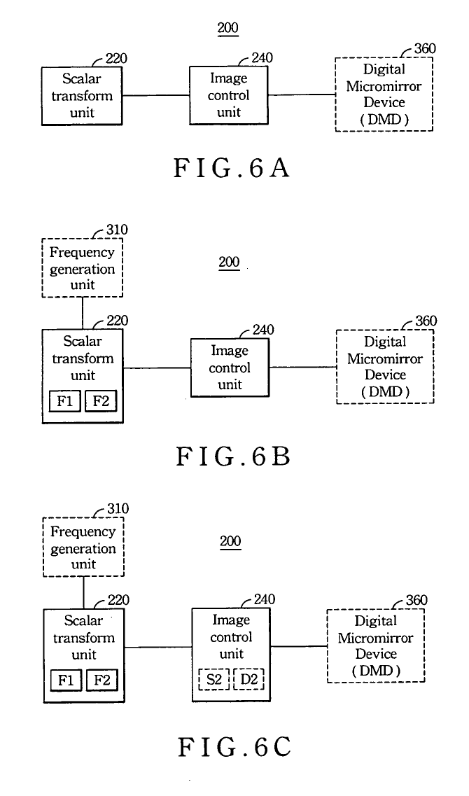

By means of the fabricating method of the DLP 200 previously discussed, if there is a desire to change the resolution of the DLP, referring to FIG. 6A, first, replace the DMD 260 with a second DMD 360 of a different resolution; next, referring to FIG. 6B, install a second frequency generation unit 310 corresponding to the resolution of the second DMD 360 to replace the frequency generation unit 210 shown in FIG. 5B; similar to FIG. 5B, write a plurality of scalar firmware F1 and F2 into the scalar transform unit 220 corresponding to the resolutions of the second DMD 360; next, referring to FIG. 6C, write a second DMD firmware D2 and a second register number S2 into the image control unit 240 corresponding to the resolutions of the second DMD 360.

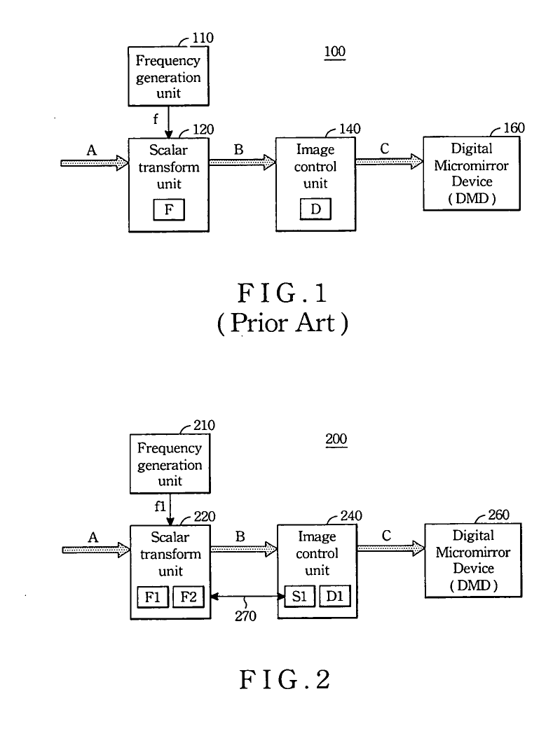

Compared with the conventional DLP 100 shown in FIG. 1 that has to switch four elements including the DMD 160, frequency generation unit 110, scalar firmware F and DMD firmware D to change the resolution of the DLP, FIGS. 6A, 6B and 6C indicate that the DLP 200 of the invention does not has to change the scalar firmware. And the second register number S2 and the second DMD firmware D2 may be written into the image control unit 240 simultaneously at the same step. Hence the same result can be achieved by merely switching three elements, including the second DMD 360, the second frequency generation unit 310 and the second DMD firmware D2 (indicated by broken lines in the drawings). Thus the DLP of the invention can reduce production burden and cost. It also may be adapted to higher DMD resolutions that might be available in the future. Hence the DLP of the invention has an improved expandability to meet future requirements.

While the embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

1. A digital light projector for supporting two or more digital micromirror devices (DMDs) of different resolutions that include a predetermined resolution, comprising:
a scalar transform unit having a plurality of scalar firmware stored therein corresponding to a plurality of resolutions including the predetermined resolution to output a digital image signal; and
an image control unit electrically connecting to the scalar transform unit having a DMD firmware and a register number stored therein corresponding to the predetermined resolution to transform the digital image signal to a level signal to control the DMD;
wherein the scalar transform unit selects and executes one of the scalar firmware that corresponds to the predetermined resolution while the digital light project is operating.

2. The digital light projector of claim 1, wherein the scalar transform unit further comprises a frequency generation unit to provide a frequency signal corresponding to the predetermined resolution.

3. The digital light projector of claim 1 further comprising a communication circuit to bridge the scalar transform unit and the image control unit to transmit the register number.

4. The digital light projector of claim 3, wherein the communication circuit is an Inter-Integrated Circuit (I2C) through which the scalar transform unit reads the register number resided in the image control unit.

5. The digital light projector of claim 3, wherein the communication circuit is a conductive wire connecting an I/O port of the scalar transform unit to another I/O port of the image control unit to transmit the register number from the image control unit to scalar transform unit.

6. The digital light projector of claim 1, wherein the image control unit has a control center to execute the DMD firmware and write the register number into the control center.

7. The digital light projector of claim 1, wherein the image control unit includes a buffer and a control center which executes the DMD firmware and writes the register number into the buffer.

8. The digital light projector of claim 7, wherein the scalar transform unit requests the control center for the register number while the digital light projector is operating.

9. The digital light projector of claim 1, wherein the register number is a single digit number, the resolutions supported by the digital light projector includes a first resolution and a second resolution, the register number being 0 when the predetermined resolution is the first resolution, and the register number being 1 when the predetermined resolution is the second resolution.

10. The digital light projector of claim 9, wherein the first resolution is XGA specification, the second resolution is SVGA specification.

11. A method for fabricating a digital light projector which includes a scalar transform unit, an image control unit and a digital micromirror device (DMD) having a predetermined resolution, the scalar transform unit transforming external image data input to a digital image signal, the image control unit transforming the digital image signal to a level signal to drive the DMD, the fabricating method comprising the steps of:
providing a selected frequency generation unit to provide a frequency signal corresponding to the predetermined resolution;
writing a plurality of scalar firmware into the scalar transform unit corresponding to a plurality of resolutions including the predetermined resolution; and
writing a DMD firmware and a register number into the image control unit corresponding to the predetermined resolution;
wherein the scalar transform unit selects and executes one of the scalar firmware that corresponds to the predetermined resolution while the digital light project is operating.

12. The method of claim 11 further comprising fabricating an Inter-Integrated Circuit (I2C) to electrically connect the scalar transform unit with the image control unit.

13. The method of claim 11, wherein the register number written in the image control unit is a single digit number.

14. The method of claim 11, wherein the scalar firmware written in the scalar transform unit correspond at least to XGA and SVGA specifications.

15. The method of claim 14, wherein the register number written in the image control unit is 0 when the predetermined resolution is XGA specification.

16. The method of claim 14, wherein the register number written in the image control unit is 1 when the predetermined resolution is SVGA specification.
